(19) United States
(12) Patent Application Publication
(10) Pub. No.: US 2022/0410421 A1
(43) Pub. Date: Dec. 29, 2022

(54) HAIR CUTTING KIT

(71) Applicant: Braun GmbH, Kronberg (DE)

(72) Inventors: Gerd Laschinski, Oberursel (DE); Markus Schuessler, Koenigstein (DE); Simone Langwasser, Bad Homburg (DE); Joachim Krauss, Seeheim-Jugenheim (DE); Bernhard Sikora, Kelkheim (DE)

(21) Appl. No.: 17/850,809

(22) Filed: Jun. 27, 2022

(30) Foreign Application Priority Data
Jun. 28, 2021 (EP) 21182060.0

(51) Int. Cl. B26B 19/38

(52) U.S. Cl. CPC B26B 19/3846; B26B 19/3853; B26B 19/3813

(57) ABSTRACT

A hair cutting kit comprises a cutting unit and a comb. The comb comprises a row of comb teeth. Some or all of the comb teeth comprise, on an outer face, a skin surface configured to glide on a user's skin, a feeding surface configured to feed hairs towards the cutting unit, and a transition surface between the skin surface and the feeding surface. The skin surface has a first surface contour line having a first radius of curvature, the feeding surface has a second surface contour line having a second radius of curvature, and the first radius of curvature is greater than the second radius of curvature.

### FIELD OF THE INVENTION

Aspects relate to a hair cutting kit. Aspects relate in particular to a hair cutting kit that comprises a comb that can be releasably attached to a cutting unit.

### BACKGROUND OF THE INVENTION

Hair trimmers or hair clippers are used, for example, for body grooming, in which the user primarily wishes to achieve an esthetic effect by thoroughly removing hair in other areas of the body, for example in the armpit area, the bikini zone or in intimate areas.

When a hair trimmer is used directly on the skin, the hair is cut to a determined by the blade configuration of the trimmer To achieve longer hair lengths, a comb may be used that can be attached to the device. Such a comb is also referred to as distance comb.

Distance combs can be shaped in such a way that a tip of a comb tooth is shaped as a sphere or is shaped to approximate a sphere. The surfaces are radiused to create a good skin feel. A skin surface of the comb tooth that abuts on the user's skin and/or a feeding surface of the comb tooth that feeds hairs towards a cutting unit may also be provided with a radius, which is smaller than a radius at the comb tooth tip.

However, facial skin has mechanical characteristics that are different from mechanical characteristics of the skin in other body areas, such as in the armpit area or the intimate area. Combs with a comb tooth geometry as described above can cause the skin to bulge up between the comb teeth. This applies in particular in areas (such as the armpit area or the intimate area) where the skin is thinner and more flexible than facial skin. A comb tooth geometry as described above may be prone to acting as a funnel, so that the skin in the funnel is pushed together and bulges upwards. This bulging skin can then enter the cutting system, which increases the risk of injury. If the comb is used for short distances, there is a risk that the bulged-up skin can be cut by the blade.

Many conventional cutting unit-comb kits are optimized for use with facial skin. When such kits are used in areas of the body where the skin is thinner or more flexible than facial skin (such as the armpit or intimate area), the skin is at a risk of being cut by the blade(s) of the cutting unit.

It is an object of the invention to provide devices and/or kits that mitigate at least some of the above shortcomings in the art.

### SUMMARY OF THE INVENTION

There is a need for enhanced hair cutting kits. There is a need for hair cutting kits, in particular for body hair trimming, that mitigate the risk of skin injury while affording good cutting efficacy and user comfort. Alternatively or additionally, there is a need for hair cutting kits, in particular for body hair trimming, which mitigate pronounced skin bulging effects. Alternatively or additionally, there is a need for hair cutting kits, that include a comb that is suitable not only for use on facial skin but that can be used on other body areas while mitigating the risk of skin injury in body areas where the skin is thinner and/or more flexible than facial skin.

According to an aspect, a hair cutting kit comprises a handle, a cutting unit, and a comb.

The cutting unit is arranged on or arrangeable on the handle and comprises a stationary blade and a moveable blade. The stationary blade comprises a row of first blade teeth having free first blade tooth ends. The moveable blade may be configured to reciprocate relative to the stationary blade.

The comb is configured to be reversibly releasably assembled with the cutting unit. The comb has a skin surface. The comb comprises a base portion opposite the skin surface and a row of comb teeth. The row of comb teeth extends in a first direction. Adjacent comb teeth are separated along the first direction by gaps. Each comb tooth has a mid-plane that is transverse (e.g., perpendicular) to the first direction. Each comb tooth extends along its mid-plane.

Some or all of the comb teeth comprise, on an outer face that is arranged to face away from the stationary blade and from the moveable blade, a skin surface configured to glide on a user's skin, a feeding surface configured to feed hairs towards the cutting unit, and a transition surface between the skin surface and the feeding surface.

The skin surface has a first surface contour line having a first radius of curvature. The feeding surface has a second surface contour line having a second radius of curvature. The first radius of curvature may be greater than the second radius of curvature.

Alternatively or additionally, the transition surface may have a third surface contour line having a third radius of curvature that may be smaller than the first and/or second radius of curvature.

According to an aspect, a hair cutting kit comprises a handle, a cutting unit, and a comb.

The cutting unit is arranged on or arrangeable on the handle and comprises a stationary blade and a moveable blade. The stationary blade comprises a row of first blade teeth having free first blade tooth ends. The moveable blade may be configured to reciprocate relative to the stationary blade.

The comb is configured to be reversibly releasably assembled with the cutting unit. The comb has a skin surface. The comb comprises a base portion opposite the skin surface and a row of comb teeth. The row of comb teeth extends in a first direction. Adjacent comb teeth are separated along the first direction by gaps. Each comb tooth has a mid-plane that is transverse (e.g., perpendicular) to the first direction. Each comb tooth extends along its mid-plane.

Some or all of the comb teeth comprise, on an outer face that is arranged to face away from the stationary blade and from the moveable blade, a skin surface configured to glide on a user's skin, a feeding surface configured to feed hairs towards the cutting unit, and a transition surface between the skin surface and the feeding surface.

A first cylinder segment surface circumscribed about the skin surface has a first radius of curvature. A second cylinder segment surface circumscribed about the feeding surface has a second radius of curvature. The first radius of curvature is greater than the second radius of curvature.

According to an aspect, a comb for use with a hair cutting unit is provided. The comb is configured to be reversibly releasably assembled with the cutting unit. The comb comprises a base portion and a row of comb teeth. The row of comb teeth extends in a first direction. Adjacent comb teeth are separated along the first direction by gaps. Each comb tooth has a mid-plane that is transverse (e.g., perpendicular) to the first direction. Each comb tooth may extend along its mid-plane.

Some or all of the comb teeth comprise, on an outer face that is arranged to face away from the stationary blade and from the moveable blade, a skin surface configured to glide on a user's skin, a feeding surface configured to feed hairs towards the cutting unit, and a transition surface between the skin surface and the feeding surface.

The skin surface has a first surface contour line having a first radius of curvature, the feeding surface has a second surface contour line having a second radius of curvature.

The first radius of curvature may be greater than the second radius of curvature.

According to an aspect, a use of a comb for reducing skin bulging, in particular in an armpit or intimate body area, when assembled with a hair cutting unit is provided. The use comprises reversibly releasably assembling the comb with the cutting unit. The comb comprises a base portion and a row of comb teeth. The row of comb teeth extends in a first direction and adjacent comb teeth are separated along the first direction by gaps. Each comb tooth has a mid-plane that is transverse (e.g., perpendicular) to the first direction. Each comb tooth extends along its mid-plane. Some or all of the comb teeth comprise, on an outer face that is arranged to face away from the stationary blade and from the moveable blade, a skin surface configured to glide on a user's skin, a feeding surface configured to feed hairs towards the cutting unit, and a transition surface between the skin surface and the feeding surface. The skin surface has a first surface contour line having a first radius of curvature, the feeding surface has a second surface contour line having a second radius of curvature. The first radius of curvature may be greater than the second radius of curvature.

According to an aspect, a hair cutting device component is provided. The hair cutting device component comprises a base and a row of teeth. The teeth extend from the base. The row of teeth extends in a first direction. Each tooth has a mid-plane that is perpendicular to the first direction. Some or all of the teeth comprise, on an outer face that is exposed during use, a first surface, a second surface, and a transition surface between the first and second surfaces.

The first surface has a first surface contour line having a first radius of curvature. The second surface has a second surface contour line having a second radius of curvature. The first radius of curvature may be greater than the second radius of curvature.

Alternatively or additionally, the transition surface may have a third surface contour line having a third radius of curvature that may be smaller than the first and/or second radius of curvature.

Various effects are attained. The risk of skin injury is mitigated while affording good cutting efficacy. The comb can mitigate the risk of skin injury in an armpit and/or intimate area, even when used with a cutting unit designed for use on facial skin.

These and other advantages become more apparent from the following description giving reference to the drawings and possible examples.

### BRIEF DESCRIPTION OF THE DRAWINGS

FIG. 1 is a view of a hair cutting kit.

FIG. 2 is a perspective view of a comb of the hair cutting kit.

FIG. 3 is another perspective view of the comb.

FIG. 4 is a plan view showing comb teeth and cutting blades.

FIG. 5 is a partial detail view of the comb.

FIG. 6 is a perspective view of a comb tooth.

FIG. 7 is a perspective view of a comb tooth.

FIG. 8 is a perspective view of a comb tooth.

FIG. 9 is a plan view showing comb teeth and cutting blades.

FIG. 10 is a partial cross-sectional view of a hair cutting kit with the comb assembled with the cutting unit.

FIG. 11 is a view of a comb tooth.

FIGS. 12 to 15 are cross-sectional views of the comb tooth.

FIG. 16 is a cross-sectional view of a comb tooth of a comb of a hair cutting kit.

FIG. 17 is another cross-sectional view of a comb tooth of a comb of a hair cutting kit.

FIG. 18 is a view that schematically illustrates operation of a hair cutting kit according to an aspect.

FIG. 19 is a view that schematically illustrates operation of a hair cutting kit not according to an aspect.

FIG. 20 is a view that schematically illustrates operation of a hair cutting kit according to an aspect.

FIG. 21 is a view that schematically illustrates operation of a hair cutting kit not according to an aspect.

FIG. 22 is a view that schematically illustrates operation of a hair cutting kit according to an aspect.

FIGS. 23 and 24 are views that schematically illustrates operation of a hair cutting kit not according to an aspect.

FIG. 25 is a block diagram of a handle of the hair cutting kit.

### DETAILED DESCRIPTION OF THE INVENTION

Aspects will be described with reference to the drawings in which similar or identical reference numerals designate features or elements that are similar or identical in construction, operation, and/or function.

Aspects relate to hair cutting kits. The hair cutting kit may comprise a handle, a cutting unit that may be or may be comprised by a trimmer head, and a comb. The comb is configured to mitigate the risk of pronounced skin bulging that could lead to skin injury while ensuring good cutting efficacy.

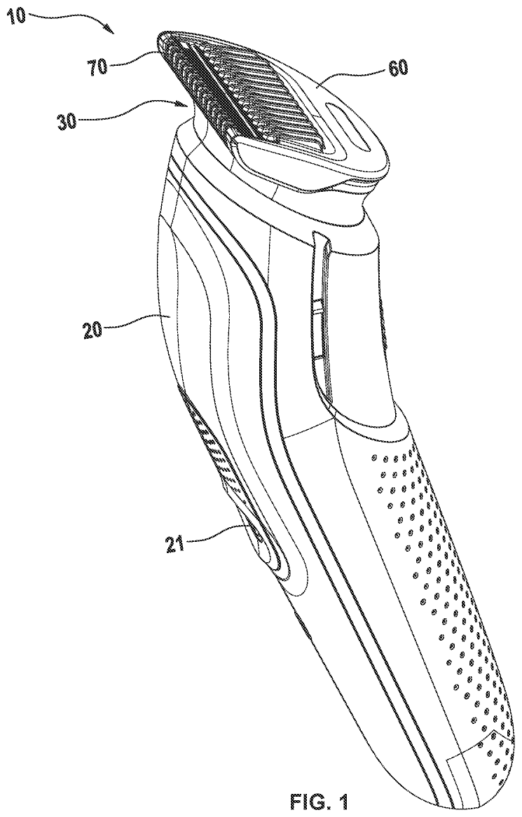

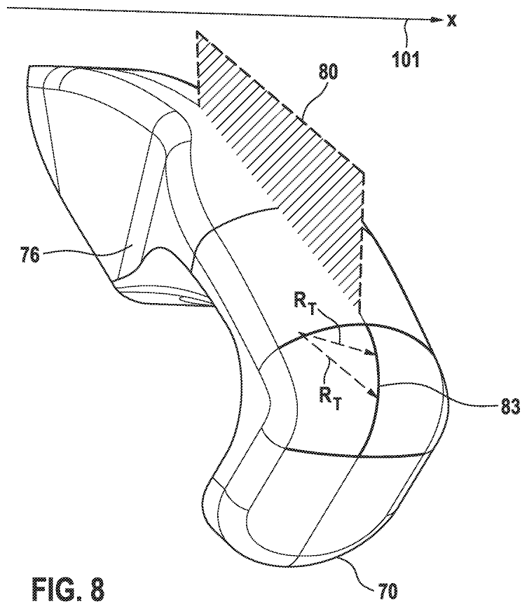

Before the kits and devices of FIGS. 1 to 25 are discussed, different aspects are described more in detail. These aspects disclose further features, advantages and possibilities of use that can be combined in any useful combination.

As used herein, the term “first direction” refers to a direction along which teeth are arranged. The first direction may be determined as, e.g., direction of a line interconnecting free ends of outermost comb teeth arranged on opposite ends of a row of comb teeth of a comb. Alternatively or additionally, the first direction may be determined as, e.g., direction of a line interconnecting tips of outermost blade teeth arranged on opposite ends of a row of blade teeth of a stationary blade of a cutting unit. Alternatively or additionally, the first direction may be determined as, e.g., direction along which a moveable blade of a cutting unit is reciprocatingly moveable relative to a stationary blade.

According to an aspect, a hair cutting kit comprises a handle, a cutting unit, and a comb.

The cutting unit comprises a stationary blade and a moveable blade. The stationary blade comprises a row of first blade teeth having free first blade tooth ends. The moveable blade may be configured to reciprocate relative to the stationary blade (e.g., along a first direction).

The comb is configured to be reversibly releasably assembled with the cutting unit. The comb has a skin surface. The comb comprises a base portion opposite the skin surface and a row of comb teeth. The row of comb teeth extends in a first direction and adjacent comb teeth are separated along the first direction by gaps. Each comb tooth has a mid-plane that is transverse to the first direction. Each comb tooth may extend along its mid-plane.

Some or all of the comb teeth comprise, on an outer face that is arranged to face away from the stationary blade and from the moveable blade, a skin surface configured to glide on a user's skin, a feeding surface configured to feed hairs towards the cutting unit, and a transition surface between the skin surface and the feeding surface. The outer face is the face that remains exposed during use for abutment on the skin and/or for feeding hairs towards the cutting unit.

The skin surface has a first surface contour line having a first radius of curvature. The feeding surface has a second surface contour line having a second radius of curvature. The first radius of curvature may be greater than the second radius of curvature.

By virtue of this construction, the risk of skin bulging at the skin surface is reduced because the curvature of the skin surface is less pronounced than that of the feeding surface. Good cutting efficacy is maintained because the feeding surface has a curvature that is more pronounced than that of the skin surface, allowing hairs to be efficiently guided towards the cutting unit.

Alternatively or additionally, the transition surface may have a third surface contour line having a third radius of curvature that may be smaller than the first and/or second radius of curvature.

By virtue of this construction, the risk of the comb tooth pushing a hair down towards the skin is decreased and the probability of the comb tooth lifting a hair upwards, so that it can be cut efficiently, is increased. Cutting efficacy is increased.

The third surface contour line may extend in a plane that is orthogonal to planes in which the first and/or second surface contour lines extend. This takes into consideration that the curve along which the comb assembled on the cutting unit is moved during use is more relevant for lifting hairs for guiding them towards the cutting unit.

The first surface contour line may extend in a first plane that is orthogonal to the mid-plane of the comb tooth. The second surface contour line may extend in a second plane that is orthogonal to the mid-plane of the comb tooth. The first surface contour line may extend in a plane that, when the comb is assembled with the cutting unit, is transverse (e.g., perpendicular) to a plane along which the moveable blade abuts the stationary blade. This takes into consideration that the curvature in a plane perpendicular to the mid-plane of the tooth is more relevant for skin bulging and/or guiding hairs towards the cutting unit at the feeding surface.

The first and second contour lines may be arc segments, e.g., circular arc segments, or may approximate arc segments, e.g., circular arc segments. User comfort can be enhanced thereby.

The first contour line may be flat, i.e., the first radius of curvature may be infinite. The risk of pronounced skin bulging is reduced thereby.

The first surface contour line may be spaced from the free comb tooth end. Alternatively or additionally, the first surface contour line may be arranged on the skin surface in an intermediate region between the free comb tooth end and the transition surface.

The first radius of curvature may be a radius of curvature of a first cylinder circumscribed about the skin surface. Alternatively or additionally, the first radius of curvature may be a radius of curvature of a first cylinder circumscribed about the skin surface and tangential to the skin surface at a first line of intersection at which the mid-plane intersects the skin surface. Alternatively or additionally, the first radius of curvature may be a radius of curvature of a first cylinder circumscribed about at least a portion of the skin surface that is intermediate between the free comb tooth end and the transition surface.

Alternatively or additionally, the second surface contour line may extend in a plane that, when the comb is assembled with the cutting unit, is spaced from a plane along which the moveable blade abuts the stationary blade.

Alternatively or additionally, the second surface contour line may be a second arc segment that, when the comb is assembled, extends in a plane that is parallel to a plane along which the moveable blade abuts the stationary blade or that is tilted relative to the plane along which the moveable blade abuts the stationary blade, with tilt being about a tilt axis parallel to the plane along which the moveable blade abuts the stationary blade.

Alternatively or additionally, the second surface contour line may be a second arc segment on a portion of the comb tooth that is shaped as a second cylinder segment surface or that approximates a second cylinder segment surface.

The second surface contour line may be spaced from the base portion of the comb. Alternatively or additionally, the second surface contour line may be arranged on the feeding surface in an intermediate region between the base portion of the comb and the transition surface.

The second radius of curvature may be a radius of curvature of a second cylinder circumscribed about the feeding surface. Alternatively or additionally, the second radius of curvature may be a radius of curvature of a second cylinder circumscribed about the feeding surface and tangential to the feeding surface at a second line of intersection at which the mid-plane intersects the feeding surface. Alternatively or additionally, the second radius of curvature may be a radius of curvature of a second cylinder circumscribed about at least a portion of the feeding surface that is intermediate between the base portion and the transition surface.

The third surface contour line may extend in the mid-plane of the comb tooth. The third surface contour line may be a circular arc segment. The transition surface may be free from edges.

The transition surface may be shaped as or may comprise a spheroidal cap surface. This provides a smooth transition between skin surface and feeding surface without sharp edges is provided, enhancing user comfort.

The transition surface may be arranged on a leading edge of the comb in an operational movement direction when the comb is assembled with the cutting unit. This ensures that hairs may be lifted towards an upright position by the transition surface.

Each comb tooth may have a J-shape or hook shape. This configuration allows the comb teeth to partially surround the stationary and/or moveable blades, coming from the side of the moveable blade. The risk of skin injury can be mitigated.

The comb may be configured such that, when assembled with the cutting unit, each comb tooth extends from the base portion along the moveable blade, around a line along which the first blade tooth ends are positioned, and to a free comb tooth end.

The comb may be configured such that, when assembled with the cutting unit, the free comb tooth end of some or all of the comb teeth partially overlaps at least some of the first blade teeth when viewed in a viewing direction orthogonal to a plane along which the moveable blade abuts on the stationary blade. The risk of skin injury can be mitigated while allowing the blade system of the cutting unit to be positioned closely to the skin surface.

The comb may further comprise ridges extending transversely to the first direction. The ridges facilitate gliding of the comb along the skin.

The ridges may be separated from the free comb tooth ends of the comb teeth by a further gap. This facilitates that the skin can get close to the cutting unit, attaining good cutting efficacy.

Some, a majority, or all of the ridges may extend along the mid-planes of the comb teeth. A number of ridges may be equal to a number of comb teeth. Such a configuration can increase gliding during use.

The ridges may project from an upper surface of the comb. A top of the ridges may have a varying height, as measured from the upper surface of the comb. The upper surface may be the major surface of the comb that remains exposed when the comb is assembled with the cutting unit.

The ridges may be inclined downward as they approach the comb teeth. The ridges may have front ends which are positioned closest to the comb teeth and rear ends which are positioned furthest away from the comb teeth. The front ends of the ridges may be arranged at a lower height, as measured from the upper surface of the comb, than the skin surfaces of the comb teeth, or at approximately the same height. The front ends of the ridges may be arranged at a lower height, as measured from the upper surface of the comb, than the free comb tooth ends. Gliding of the comb on the skin can be improved thereby, or at approximately the same height.

Each comb tooth may have a comb tooth width. The comb tooth width may be a distance between two outermost tangential planes to a comb tooth, with the outermost tangential planes being perpendicular to the first direction.

The first radius of curvature may be greater than the comb tooth width. The first radius of curvature may be at least 1.2 times, at least 1.3 times, at least 1.4 times, or at least 1.5 times the comb tooth width. The risk of pronounced skin bulging is mitigated by providing a first radius of curvature at the skin surface that is within this range.

The second radius of curvature may be smaller than the comb tooth width. The second radius of curvature may be at most 0.95 times, at most 0.90 times, at most 0.85 times, or at most 0.80 times the comb tooth width. Efficient feeding of hairs towards the cutting unit is attained thereby.

The second radius of curvature may be greater than 0.5 times, greater than 0.6 times, or greater than 0.7 times the comb tooth width. The risk of pronounced skin bulging is mitigated by providing a first radius of curvature at the skin surface that is within this range.

The third radius of curvature may be smaller than 0.6 times, smaller than 0.55 times, smaller than 0.5 times, smaller than 0.4 times, or smaller than 0.3 times the comb tooth width. The third radius of curvature may be greater than 0.1 times, greater than 0.15 times, or greater than 0.2 times the comb tooth width. Good efficiency in lifting hairs that originally lie rather flat against the skin is attained thereby, while ensuring comfort during use.

The skin surface may comprise a first cylinder segment surface along at least a portion thereof, the first cylinder segment surface having the first radius of curvature. Alternatively or additionally, the skin surface may comprise plural facets that are angled relative to each other, wherein a first cylinder segment circumscribed about the plural facets has the first radius of curvature.

A majority of the skin surface may be formed as a first cylinder segment surface, the first cylinder segment surface having the first radius of curvature.

The feeding surface may comprise a second cylinder segment surface along at least a portion thereof, the second cylinder segment surface having the second radius of curvature. Alternatively or additionally, the feeding surface may comprise plural facets that are angled relative to each other, wherein a second cylinder segment circumscribed about the plural facets of the feeding surface has the second radius of curvature.

A majority of the feeding surface may be formed as a second cylinder segment surface, the second cylinder segment surface having the second radius of curvature.

The mid-plane may intersect the skin surface along a first intersection line, which may be straight or curved. The mid-plane may intersect the feeding surface along a second intersection line, which may be straight or curved. The first intersection line may be angled relative to the second intersection line. An angle between the first intersection line and the second intersection line may be less than 90° or less than 80°. The angle between the first intersection line and the second intersection line may be 50° or more or 60° or more or 70° or more. Good efficiency in lifting hairs that originally lie rather flat against the skin is attained thereby, while ensuring comfort during use.

Each comb tooth may have a recess at a side opposite the skin surface and/or at a side opposite the feeding surface. The recess may be arranged so as to face the stationary blade and/or the moveable blade. Each comb tooth may have at least two flank surfaces that converge in a direction towards the stationary blade and/or the moveable blade. This configuration facilitates feeding of hairs towards the cutting unit for cutting. A flaring geometry is provided for the hair as they approach the cutting unit.

A cross-sectional width of the comb tooth measured along the first direction in the first plane or in a cross-sectional plane that may be parallel to the first plane passing through the skin surface may decrease in at least part of the comb tooth in a direction away from the skin surface. Another cross-sectional width of the comb tooth measured along the first direction in the second plane or in another cross-sectional plane that may be parallel to the second plane passing through the feeding surface decreases in at least part of the comb tooth in a direction away from the feeding surface. This configuration facilitates feeding of hairs towards the cutting unit for cutting. A flaring geometry is provided for the hair as they approach the cutting unit.

The skin surface may extend at a distance of at least 0.2 mm, 0.3 mm, at least 0.4 mm, or at least 0.5 mm from a plane along which the moveable blade abuts the stationary blade. The risk of injury may be reduced thereby.

Each comb tooth may be spaced from the stationary blade by a distance that may be 0.3 mm or greater, 0.4 mm or greater, or 0.5 mm or greater. This allows efficient feeding of hair towards the cutting unit between comb and the stationary blade.

A comb tooth pitch, defined as distance between the mid-planes of the adjacent comb teeth, may be at least 1.4 times, at least 1.5 times, at least 1.6 times, or at least 1.65 times the comb tooth width. A comb tooth pitch, defined as distance between the mid-planes of the adjacent comb teeth, may be at most 3.0 times, at most 2.75 times, at most 2.5 times, at most 2.25 times, or at most 2.0 times the comb tooth width. Good cutting efficacy can be attained thereby.

A comb tooth gap width, defined as distance between the mid-planes of the adjacent comb teeth minus the comb tooth width, may be at least 0.4 times, at least 0.5 times, at least 0.6 times, or at least 0.65 times the comb tooth width. A comb tooth gap width, defined as distance between the mid-planes of the adjacent comb teeth minus the comb tooth width, may be at most 2.0 times, at most 1.75 times, at most 1.5 times, at most 1.25 times, or at most 1.0 times the comb tooth width. Good cutting efficacy can be attained thereby.

The base of the comb may have a mechanical interface for reversibly releasable attachment to the cutting unit. This allows the comb to be readily attached to and detached from the cutting unit as the need arises.

The comb may be used in association with an electric hair cutting kit for body hair trimming. For illustration, the comb may be used in association with a class of devices that is also referred to as body groomer that are intended to be used in areas of the body other than the head, including areas (such as the intimate area) that are more prone to skin bulging due to the skin characteristics in those areas.

The comb may be made from plastic.

According to an aspect, a hair cutting kit comprises a handle, a cutting unit, and a comb.

The cutting unit is arranged on or arrangeable on the handle and comprises a stationary blade and a moveable blade. The stationary blade comprises a row of first blade teeth having free first blade tooth ends. The moveable blade may be configured to reciprocate relative to the stationary blade.

The comb is configured to be reversibly releasably assembled with the cutting unit. The comb has a skin surface. The comb comprises a base portion opposite the skin surface and a row of comb teeth. The row of comb teeth extends in a first direction. Adjacent comb teeth are separated along the first direction by gaps. Each comb tooth has a mid-plane that is transverse (e.g., perpendicular) to the first direction. Each comb tooth extends along its mid-plane.

Some or all of the comb teeth comprise, on an outer face that is arranged to face away from the stationary blade and from the moveable blade, a skin surface configured to glide on a user's skin, a feeding surface configured to feed hairs towards the cutting unit, and a transition surface between the skin surface and the feeding surface.

A first cylinder segment surface circumscribed about the skin surface has a first radius of curvature. A second cylinder segment surface circumscribed about the feeding surface has a second radius of curvature. The first radius of curvature is greater than the second radius of curvature.

By virtue of this construction, the risk of skin bulging at the skin surface is reduced because the curvature of the skin surface is less pronounced than that of the feeding surface. Good cutting efficacy is maintained because the feeding surface has a curvature that is more pronounced than that of the skin surface, allowing hairs to be efficiently guided towards the cutting unit.

Alternatively or additionally, a spherical or ellipsoidal surface circumscribed about the transition surface may have a third radius of curvature that may be smaller than the first and/or second radius of curvature.

By virtue of this construction, the risk of the comb tooth pushing a hair down towards the skin is decreased and the probability of the comb tooth lifting a hair upwards, so that it can be cut efficiently, is increased. Cutting efficacy is increased.

A first center axis of the first cylinder segment surface may extend within the mid-plane of the comb tooth. A second center axis of the second cylinder segment surface may extend within the mid-plane of the comb tooth. The third radius of curvature may be a radius of a line segment on the spherical or ellipsoidal surface that extends within the mid-plane of the tooth.

Additional optional features and characteristics that may be implemented in the hair cutting kit correspond to the optional features and characteristics described in association with other aspects.

According to an aspect, a comb for use with a hair cutting unit is provided. The comb is configured to be reversibly releasably assembled with the cutting unit. The comb comprises a base portion and a row of comb teeth. The row of comb teeth extends in a first direction. Adjacent comb teeth are separated along the first direction by gaps. Each comb tooth has a mid-plane that is transverse to the first direction. Each comb tooth may extend along its mid-plane.

Some or all of the comb teeth comprise, on an outer face that is arranged to face away from the stationary blade and from the moveable blade, a skin surface configured to glide on a user's skin, a feeding surface configured to feed hairs towards the cutting unit, and a transition surface between the skin surface and the feeding surface.

The skin surface has a first surface contour line having a first radius of curvature, the feeding surface has a second surface contour line having a second radius of curvature.

The first radius of curvature may be greater than the second radius of curvature.

Alternatively or additionally, the transition surface may have a third surface contour line having a third radius of curvature that may be smaller than the first and/or second radius of curvature.

The third surface contour line may extend in a plane that is orthogonal to planes in which the first and/or second surface contour lines extend.

Additional optional features and characteristics that may be implemented in the comb correspond to the optional features and characteristics described in association with the hair cutting kit.

According to an aspect, a use of a comb for reducing skin bulging, in particular in an armpit or intimate body area, when assembled with a hair cutting unit is provided. The use comprises reversibly releasably assembling the comb with the cutting unit. The comb comprises a base portion and a row of comb teeth. The row of comb teeth extends in a first direction and adjacent comb teeth are separated along the first direction by gaps. Each comb tooth has a mid-plane that is transverse to the first direction. Each comb tooth extends along its mid-plane. Some or all of the comb teeth comprise, on an outer face that is arranged to face away from the stationary blade and from the moveable blade, a skin surface configured to glide on a user's skin, a feeding surface configured to feed hairs towards the cutting unit, and a transition surface between the skin surface and the feeding surface.

The skin surface has a first surface contour line having a first radius of curvature, the feeding surface has a second surface contour line having a second radius of curvature. The first radius of curvature may be greater than the second radius of curvature.

Alternatively or additionally, the transition surface may have a third surface contour line having a third radius of curvature that may be smaller than the first and/or second radius of curvature.

The third surface contour line may extend in a plane that is orthogonal to planes in which the first and/or second surface contour lines extend.

The first surface contour line may extend in a first plane that is orthogonal to the mid-plane of the comb tooth.

The second surface contour line may extend in a second plane that is orthogonal to the mid-plane of the comb tooth.

The third surface contour line may extend in the mid-plane of the comb tooth.

Additional optional features and characteristics that may be implemented in the use of the comb correspond to the optional features and characteristics described in association with the hair cutting kit.

According to an aspect, a hair cutting device component is provided. The hair cutting device component comprises a base and a row of teeth. The teeth extend from the base. The row of teeth extends in a first direction. Each tooth has a mid-plane that is perpendicular to the first direction. Some or all of the teeth comprise, on an outer face that is exposed during use, a first surface, a second surface, and a transition surface between the first and second surfaces.

The first surface has a first surface contour line having a first radius of curvature. The second surface has a second surface contour line having a second radius of curvature. The first radius of curvature may be greater than the second radius of curvature.

Alternatively or additionally, the transition surface may have a third surface contour line having a third radius of curvature that may be smaller than the first and/or second radius of curvature.

The third surface contour line may extend in a plane that is orthogonal to planes in which the first and/or second surface contour lines extend.

The first surface may be arranged for abutment on the user's skin.

The second surface may be arranged for guiding hairs projecting from the user's skin.

The transition surface may be shaped such that it provides a smooth transition to both the skin surface and the feeding surface.

The first surface contour line may extend in a first plane that is orthogonal to the mid-plane of the tooth.

The first surface contour line may be a first arc segment.

The first arc segment may be a first circular arc segment.

The second surface contour line may extend in a second plane that is orthogonal to the mid-plane of the tooth.

The second surface contour line may be a second arc segment.

The second arc segment may be a second circular arc segment.

The third surface contour line may be a circular arc segment.

The transition surface may be shaped as or may comprise a spheroidal cap surface.

The transition surface may be arranged on a leading edge of the cutting device component in an operational movement direction.

The cutting device component may further comprise ridges extending transversely to the first direction.

The ridges may be separated from the free comb tooth ends of the teeth by a further gap.

Some, a majority, or all of the ridges may extend along the mid-planes of the teeth.

A number of ridges may be equal to a number of teeth.

The ridges may project from an upper surface of the base.

A top of the ridges may have a varying height, as measured from the upper surface of the comb. The upper surface may be the major surface of the cutting device component that remains exposed in use.

The ridges may be inclined downward as they approach the teeth.

The ridges may have front ends which are positioned closest to the teeth and rear ends which are positioned furthest away from the teeth.

The front ends of the ridges may be arranged at a lower height, as measured from the upper surface of the base, than the first surfaces of the teeth, or at approximately the same height.

The front ends of the ridges may be arranged at a lower height, as measured from the upper surface of the base, than the free comb tooth ends, or at approximately the same height.

Each tooth may have a tooth width.

The tooth width may be a distance between two outermost tangential planes to a tooth, with the outermost tangential planes being perpendicular to the first direction.

The first radius of curvature may be greater than the tooth width.

The first radius of curvature may be at least 1.2 times, at least 1.3 times, at least 1.4 times, or at least 1.5 times the tooth width.

The second radius of curvature may be smaller than the tooth width.

The second radius of curvature may be at most 0.95 times, at most 0.90 times, at most 0.85 times, or at most 0.80 times the tooth width.

The second radius of curvature may be greater than 0.5 times, greater than 0.6 times, or greater than 0.7 times the tooth width.

The third radius of curvature may be smaller than 0.6 times, smaller than 0.55 times, smaller than 0.5 times, smaller than 0.4, or smaller than 0.3 times the tooth width.

The third radius of curvature may be greater than 0.1 times, greater than 0.15 times, or greater than 0.2 times the tooth width.

The first surface may comprise a first cylinder segment surface along at least a portion thereof, the first cylinder segment surface having the first radius of curvature.

A majority of the first surface may be formed as a first cylinder segment surface, the first cylinder segment surface having the first radius of curvature.

The second surface may comprise a second cylinder segment surface along at least a portion thereof, the second cylinder segment surface having the second radius of curvature.

A majority of the second surface may be formed as a second cylinder segment surface, the second cylinder segment surface having the second radius of curvature.

The mid-plane may intersect the first surface along a first intersection line, which may be straight or curved.

The mid-plane may intersect the second surface along a second intersection line, which may be straight or curved

The first intersection line may be angled relative to the second intersection line.

A tooth pitch, defined as distance between the mid-planes of the adjacent teeth, may be at least 1.4 times, at least 1.5 times, at least 1.6 times, or at least 1.65 times the tooth width.

A tooth pitch, defined as distance between the mid-planes of the adjacent teeth, may be at most 3.0 times, at most 2.75 times, at most 2.5 times, at most 2.25 times, or at most 2.0 times the tooth width.

A tooth gap width, defined as distance between the mid-planes of the adjacent teeth minus the tooth width, may be at least 0.4 times, at least 0.5 times, at least 0.6 times, or at least 0.65 times the tooth width.

A tooth gap width, defined as distance between the mid-planes of the adjacent teeth minus the tooth width, may be at most 2.0 times, at most 1.75 times, at most 1.5 times, at most 1.25 times, or at most 1.0 times the tooth width.

The base of the implement may have a mechanical interface for reversibly releasable attachment to the cutting unit.

The hair cutting device component may be a comb, a blade, or another component for releasable or permanent assembly on a hair cutting device.

The cutting unit component may have a mechanical interface for reversibly releasable attachment to a trimmer head.

FIG. 1 is a view of a hair cutting kit 10. The hair cutting kit 10 comprises a handle 20, a cutting unit 30 that may be formed as or be comprised by a trimmer head, and a comb 60. While only one comb 60 is shown in FIG. 1, the hair cutting kit may comprise two, three or more than three different combs, at least some of which are configured to be engaged with the cutting unit 30.

The cutting unit 30 comprises a blade system that includes a stationary blade and a moveable blade. The cutting unit 30 may be fixedly integrated with the handle 20 or may be configured for reversibly releasable attachment to the handle 20. The cutting unit 30 may be configured to be repeatedly engaged with and disengaged from the handle 20 in a destruction-free manner. As will be described in more detail below, the cutting unit 30 comprises at least one stationary blade comprising at least one row of blade teeth, and at least one moveable blade.

The comb 60 has a mechanical interface that allows the comb 60 to be selectively engaged with the cutting unit 30 in a destruction-free manner The comb 60 has comb teeth that are shaped to mitigate the risk of pronounced skin bulging while ensuring good user comfort and good cutting efficacy.

The handle 20 may comprise a control element 21 operatively coupled to a motor control of the handle 20. In response to activation of the control element 21, a motor integrated in a housing of the handle 20 may be powered on or off. An output shaft of the motor may drive, via a rotary-to-linear motion conversion mechanism, the moveable blade of the cutting unit, causing the moveable blade to oscillate in a reciprocating manner.

The handle 20 may comprise an adjustment mechanism (which is schematically shown as adjustment mechanism 27 in FIG. 25) for adjustment of the trimmer head attached to the handle 20 and/or for adjustment of the comb 60. The adjustment mechanism may allow the comb 60 to be repositioned relative to the trimmer head attached to the handle 20. The adjustment mechanism may comprise a rotary or linear adjustment mechanism.

The handle 20 has a first handle end that, in use, is remote from the user's skin, and an opposite second handle end at which the cutting unit 30 is arranged during use. A handle longitudinal direction extends from the first handle end to the opposite second handle end to which one of the trimmer heads is attached in use. As will be described in more detail below, the comb 60 has a row of comb teeth that, with the row of comb teeth extending transversely to the handle longitudinal direction when the comb 60 is assembled with the cutting unit 30.

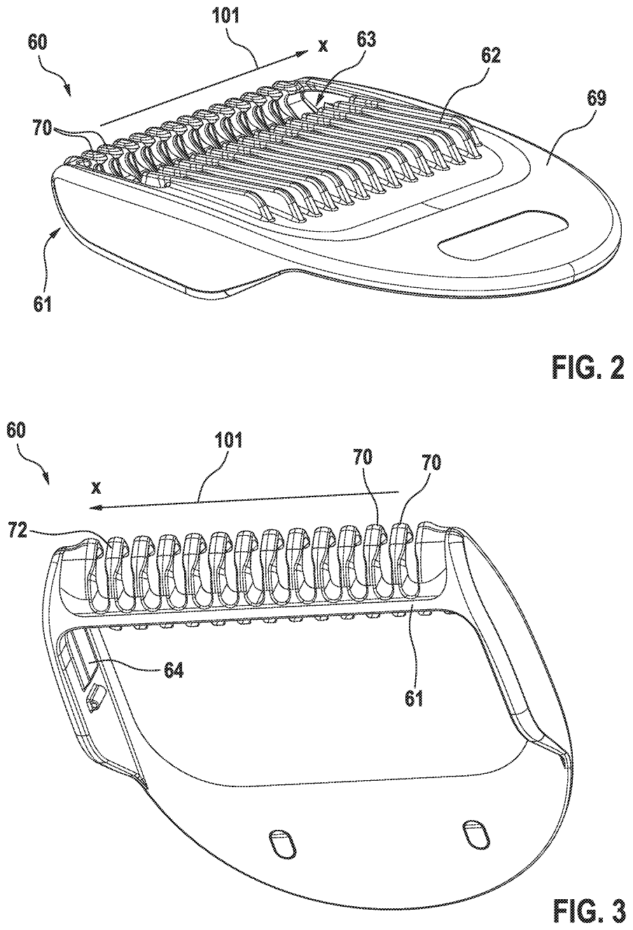

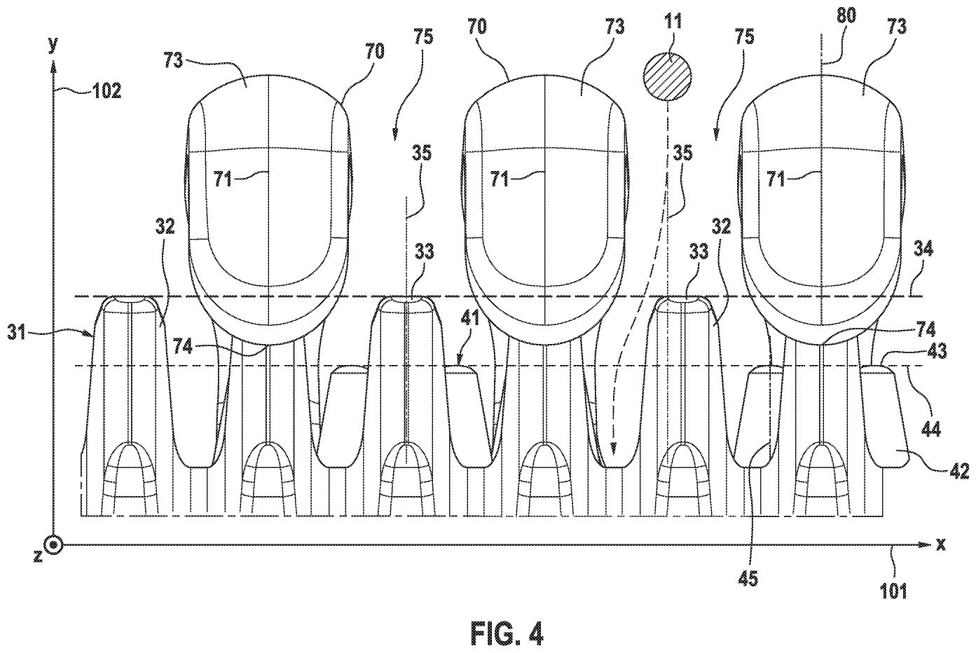

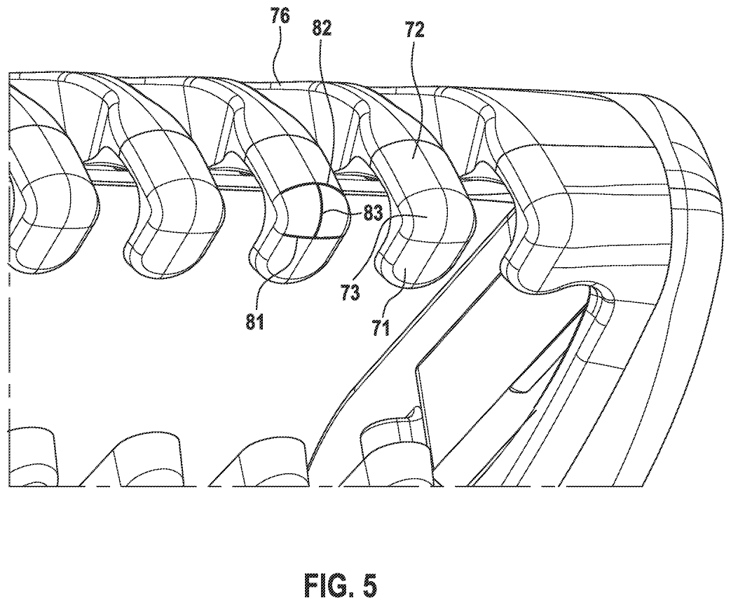

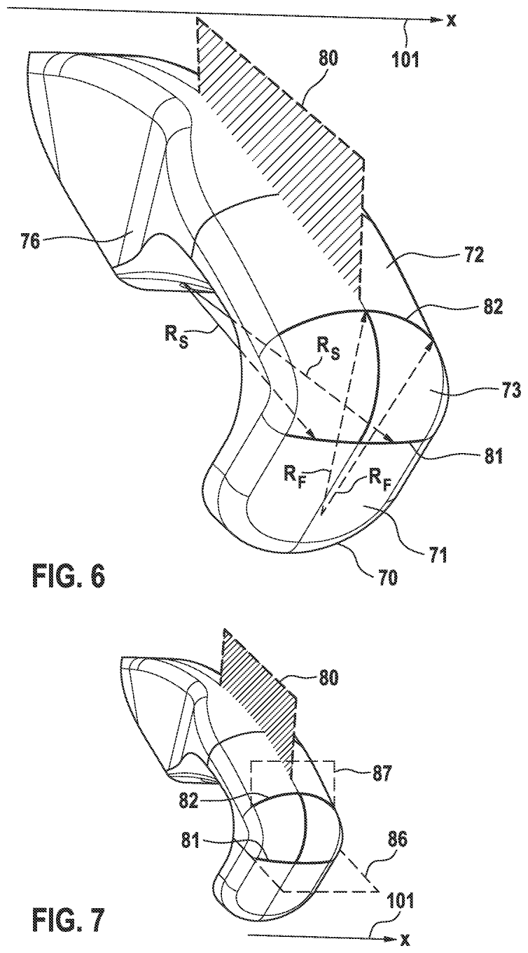

FIG. 2 is a perspective view of the comb 60. FIG. 3 is another perspective view of the comb 60. FIG. 4 is a partial plan view showing the comb 60, a stationary blade 31 of the cutting unit 30, and a moveable blade 41 of the cutting unit 30 when the comb 60 is assembled. FIG. 5 is a partial perspective view showing comb teeth 70 of the comb 60. Additional geometrical characteristics and features of the comb will be described subsequently in more detail with reference to FIGS. 6 to 24.

The comb 60 is configured to be reversibly releasably assembled with the cutting unit 30. The comb 60 comprises a base portion 61. The base portion 61 is arranged to face towards the handle 20 when the comb 60 is assembled with the cutting unit 30. The comb 60 has a skin surface 69 that is exposed when the comb 60 is assembled with the cutting unit 30 and that may face upward, away from the handle, when the comb 60 is assembled with the cutting unit 30. The base portion 61 is arranged opposite the skin surface 69. The comb 60 may have a mechanical interface 64 for reversibly releasable coupling of the comb 60 with the handle 20 and/or cutting unit 30. The mechanical interface may be located at or proximate to the base portion 61 or at another location on the comb 60.

The comb 60 comprises a row of comb teeth 70. The row of comb teeth 70 extends in a first direction 101. Adjacent comb teeth 70 are separated along the first direction 101 by gaps 75. The comb teeth 70 may respectively have a J-shape (also referred to as hook shape), with a free comb tooth end 74.

The comb teeth 70 are generally arranged to extend from the base portion 61 (where a comb tooth base 76 may be located) along a face of the moveable blade 41 that does not abut the stationary blade 31, then transition into a portion that may optionally extend around blade tooth tips of blade teeth of the stationary blade 31, to free comb tooth ends 74. The free comb tooth ends 74 may optionally be arranged in overlapping relationship with portions of at least some blade teeth of the stationary blade 31.

The comb teeth 70 may respectively have mid-planes 80. The comb teeth 70 may extend along their mid-planes 80. The mid-planes 80 extend perpendicular to the first direction 101 (which is also referred to as x-direction herein and which may correspond to the extension direction of the row of comb teeth, the row of blade teeth of the stationary blade and/or the movement direction of the moveable blade). The mid-planes of different comb teeth 70 extend parallel to each other at a distance that defines a comb tooth pitch.

The comb 60 may further comprise ridges 62 extending transversely to the first direction 101. The ridges 62 may be separated from the free comb tooth ends 74 of the comb teeth 70 by a further gap 63.

Some, a majority, or all of the ridges 62 may extend along the mid-planes 80 of the comb teeth 70. A number of ridges 62 may be equal to a number of comb teeth 70.

The ridges 62 may project from an upper surface 69 of the comb 60. A top of the ridges 62 may have a varying height, as measured from the upper surface 69 of the comb 60. The ridges 62 may be inclined downward as they approach the comb teeth 70. The ridges 62 may have front ends which are positioned closest to the comb teeth 70. The front ends of the ridges 62 may be arranged at a lower height, as measured from the upper surface 69 of the comb 60, than the free comb tooth ends 74 of the comb teeth 70, or the front ends of the ridges 62 may be arranged at approximately the same height, as measured from the upper surface 69 of the comb 60, as the free comb tooth ends 74 of the comb teeth 70.

As seen in the plan view of FIG. 4, the stationary blade 31 comprises a first row of first blade teeth 32. When the comb 60 is assembled with the cutting unit, the row of first blade teeth 32 and the row of comb teeth 70 extend in the same first direction 101 (which is also referred to as x-direction herein).

The first blade teeth 32 may respectively have one or two cutting edges for performing scissor cutting. Free ends 33 of the first blade teeth 32 may be arranged on a line 34 that extends along the first direction 101. Each first blade tooth 32 of the stationary blade 31 may have a central longitudinal axis 35 that extends transverse to the first direction 101 in a second direction 102 (which is also referred to as y-direction herein). A third direction 103 orthogonal to the first direction 101 and the second direction 102 is also referred to as z-direction herein. The viewing direction in the plan view of FIG. 4 is along the z-axis, i.e., orthogonal to the first direction 101 and the second direction 102.

The moveable blade 41 comprises a second row of second blade teeth 42. When the comb 60 is assembled with the cutting unit, the row of second blade teeth 42 and the row of comb teeth 70 extend in the same first direction 101.

The second blade teeth 42 may respectively have one or two cutting edges for performing scissor cutting. Free ends 43 of the second blade teeth 42 may be arranged on a line 44 that extends along the first direction 101. Each second blade tooth 42 of the moveable blade 41 may have a central longitudinal axis 45 that extends transverse in the second direction 102 transverse to the first direction 101.

When the comb 60 is assembled with the cutting unit 30, each comb tooth 70 may extend from the base portion 61 along the moveable blade 41, and to a free comb tooth end 74. Optionally, each comb tooth 70 may extend around the line 34 along which the first blade tooth ends 33 are positioned. The free comb tooth ends 74 may be arranged in partially overlapping relationship with some of the first blade teeth 41, when viewed in a plan view with a viewing direction orthogonal to the first and second directions 101, 102.

During operation, a hair 11 is guided by a feeding surface 72 to gaps between adjacent first blade teeth 33 for performing a cutting operation.

Each comb tooth 70 has an outer face. The outer face may be directed away from the stationary blade 31 and the moveable blade 41 when the comb 60 is assembled with the cutting unit 30. The outer face may remain exposed for abutment on the skin and/or for feeding hair when the comb 60 is assembled with the cutting unit 30. Lateral flanks of the comb teeth 70 may be adjacent to the outer face that is directed away from the stationary blade 31 and the moveable blade 41. The lateral flanks of the comb teeth 70 may extend from the outer face towards the stationary blade 31 and the moveable blade 41.

Some, a majority, or all of the comb teeth 70 comprise, on the outer face, a skin surface 71 configured to glide on a user's skin 110, a feeding surface 72 configured to feed hairs towards the cutting unit 30, and a transition surface 73 between the skin surface 71 and the feeding surface 72.

The transition surface 73 may also be operative to lift hairs for improved cutting performance. The transition surface 73 provides a smooth transition between the skin surface 71 and the feeding surface 72 of the comb tooth.

The transition surface 73 is arranged on a leading edge of the comb 60 when the comb 60 is assembled with the cutting unit 30 and the assembled device is moved in an operational movement direction.

As best seen in FIGS. 5 to 8, the skin surface 71 has a first surface contour line 81 extending in a first plane 86 orthogonal to the mid-plane 80. The first surface contour line 81 may be a circular arc segment or an elliptical arc segment. The first surface contour line 81 may have a first radius of curvature R_{S}. The first radius of curvature may also be infinite, in which case the first surface contour line 81 is flat and the skin surface 71 has a flat portion for abutment on the skin.

The feeding surface 72 has a second surface contour line 82 extending in a second plane 87 orthogonal to the mid-plane 80. The second surface contour line 82 may be another circular arc segment or another elliptical arc segment. The second surface contour line 82 may have a second radius of curvature R_{F}, wherein the first radius of curvature R_{S} is greater than the second radius of curvature R_{F}.

The second plane 87 may be parallel to the x-y plane spanned by the first and second directions 101, 102, and the first plane 86 may be oblique (e.g., perpendicular) to the x-y plane spanned by the first and second directions 101, 102. In other aspects, both the first plane 86 and the second plane 87 are angled by angles different from 90°, in particular less than 90°, relative to the x-y plane spanned by the first and second directions 101, 102. The first plane 86 and the second plane 87 may be non-orthogonal.

The transition surface 73 has a third surface contour line 83 extending in the mid-plane 80. The third surface contour line 83 may be yet another circular arc segment or yet another elliptical arc segment. The third surface contour line 83 may have a third radius of curvature R_{T}.

The first radius of curvature R_{S} is greater than the second radius of curvature R_{F}. The third radius of curvature R_{T} is smaller than the second radius of curvature R_{F} and smaller than the first radius of curvature R_{S}. Such a configuration mitigates the risk of pronounced skin bulging and the resultant risk of skin injury during operation, while attaining good user comfort and cutting efficacy.

The different radii of curvature R_{S}>R_{F}>R_{T} reduce an upward bulging of the skin. The clearly different radii R_{S}>R_{F}>R_{T} of the comb teeth 70 prevent a funnel effect as far as possible, so that the skin no longer bulges so much, while maintaining user comfort and without compromising cutting efficacy in an unacceptable way. While different geometrical conditions may allow even shorter hair lengths to be attained, this would adversely affect the feeling on the skin and/or efficiency would be reduced.

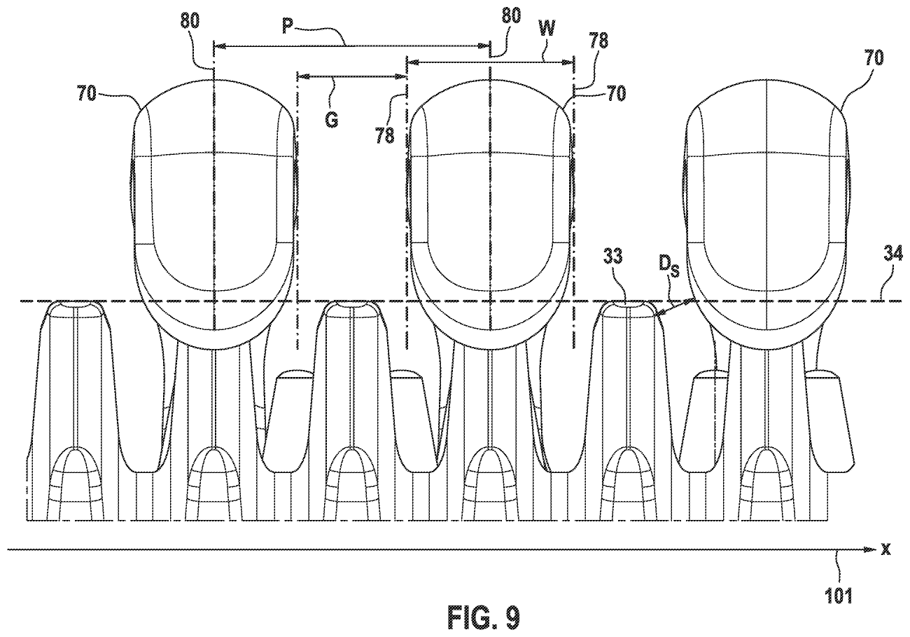

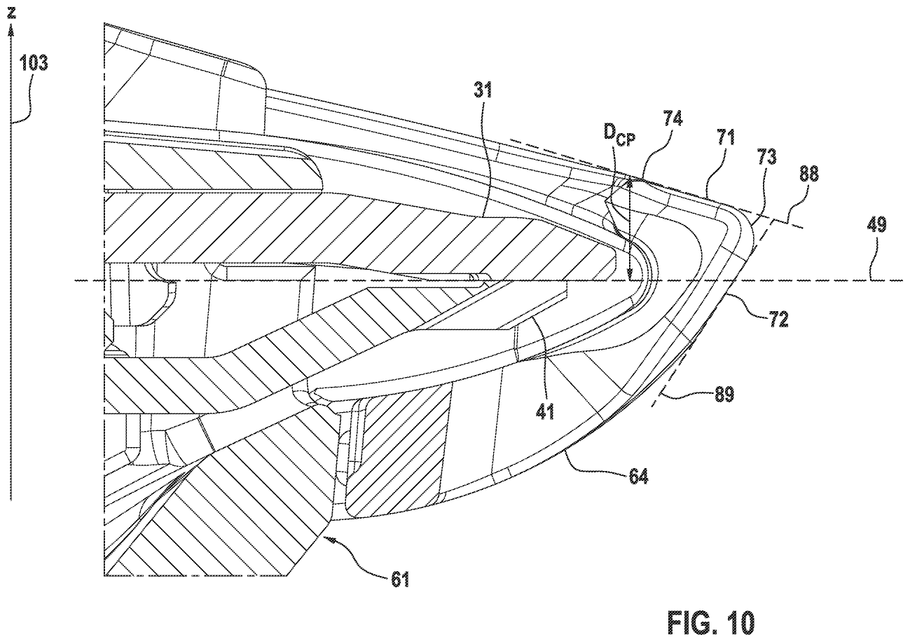

Referring to FIGS. 9 and 10, the first radius of curvature R_{S}, the second radius of curvature R_{F}, and/or the third of curvature R_{T} may be matched to a comb tooth width, size of the comb tooth gap, and/or comb tooth pitch.

The comb teeth 70 respectively have a comb tooth width W. The comb tooth width 70 is a distance between two outermost tangential planes 78 to a comb tooth 70 with the outermost tangential planes 78 being perpendicular to the first direction 101. A comb tooth pitch P may be defined as distance between mid-planes 80 of adjacent comb teeth 70. A comb tooth gap width G may be defined as a difference between comb tooth pitch P and comb tooth width W, G=P−W.

The first radius of curvature R_{S} may greater than the comb tooth width W, e.g., at least 1.2 times, at least 1.3 times, at least 1.4 times, or at least 1.5 times the comb tooth width W. The second radius of curvature R_{F} may be smaller than the comb tooth width W, e.g., at most 0.95 times, at most 0.90 times, at most 0.85 times, or at most 0.80 times the comb tooth width W. The second radius of curvature R_{F} may be greater than 0.5 times, greater than 0.6 times, or greater than 0.7 times the comb tooth width W. The risk of pronounced skin bulging is mitigated while attaining good feeding efficiency.

The third radius of curvature R_{T} may be smaller than 0.6 times, smaller than 0.55 times, smaller than 0.5 times, smaller than 0.4, or smaller than 0.3 times the comb tooth width W. The third radius of curvature R_{T} may be greater than 0.1 times, greater than 0.15 times, or greater than 0.2 times the comb tooth width W. Good efficiency in lifting hairs that originally lie rather flat against the skin is attained thereby, while ensuring comfort during use.

The comb tooth pitch P may be at least 1.4 times, at least 1.5 times, at least 1.6 times, or at least 1.65 times the comb tooth width W. The comb tooth pitch P may be at most 3.0 times, at most 2.75 times, at most 2.5 times, at most 2.25 times, or at most 2.0 times the comb tooth width W. This provides good cutting efficiency while adequately protecting the skin from direct contact with cutting edges of the stationary blade 31 and/or moveable blade 41.

The comb tooth gap width, defined as distance between the mid-planes of the adjacent comb teeth minus the comb tooth width, may be at least 0.4 times, at least 0.5 times, at least 0.6 times, or at least 0.65 times the comb tooth width.

The comb tooth gap width G may be at most 2.0 times, at most 1.75 times, at most 1.5 times, at most 1.25 times, or at most 1.0 times the comb tooth width W. This provides good cutting efficiency.

As illustrated in FIG. 10, the skin surface 71 of each comb tooth 70 may extend at a distance D_{CP} spaced from a plane 49 along which the moveable blade 41 abuts the stationary blade 31. The distance D_{CP} may be at least 0.2 mm, 0.3 mm, at least 0.4 mm, or at least 0.5 mm, to reduce the risk of injuring the skin.

As best seen in FIG. 9, each comb tooth 70 may be spaced from the stationary blade 31 by a distance D_{S}. The distance D_{S} may be 0.3 mm or greater, 0.4 mm or greater, or 0.5 mm or greater, to allow hairs to pass through the gap between the comb tooth 70 and the stationary blade 31.

As illustrated in FIG. 10, the mid-plane 80 may intersect the skin surface 71 along a first intersection line 88 which may be substantially straight. The mid-plane 80 may intersect the feeding surface 72 along a second intersection line 89 which may be substantially straight. The first intersection line 88 is angled relative to the second intersection line 89. An angle between the first intersection line 88 and the second intersection line 89 is less than 90° or less than 80°. The angle between the first intersection line 88 and the second intersection line 89 may be 30° or more, 40° or more, 50° or more, 60° or more or 70° or more. The first intersection line 88 and the second intersection line 89 my both be angled relative to a plane 49 along which the moveable blade 41 abuts on the stationary blade 31 when the comb 60 is assembled. Such a transition angle between the skin surface 71 and the feeding surface 72 assists in lifting hairs and/or otherwise attaining feeding efficiency.

For illustration, in an exemplary implementation, the comb tooth width W may be at least 0.7 mm and at most 1.5 mm. This range provides good skin protection and stability when the comb is formed of a plastic. The comb tooth gap width G may be 1.5 mm or less, 1 mm or less, e.g. about 0.9 mm. The comb tooth pitch P may exceed 2.0 mm and may be less than 3 mm. The first radius of curvature R_{S} may be 1.0 mm or greater. The second radius of curvature R_{F} may be 0.7 mm or greater and 1.3 mm or less. The third radius of curvature R_{T} may be 0.2 mm or greater and 0.6 mm or less. The height of the skin surface 71 above the cutting plane 49, D_{CP}, may be 1.5 mm or less. The spacing D_{S} of any comb tooth 70 and the stationary blade 31 may be 0.2 mm or greater, or 0.3 mm or greater.

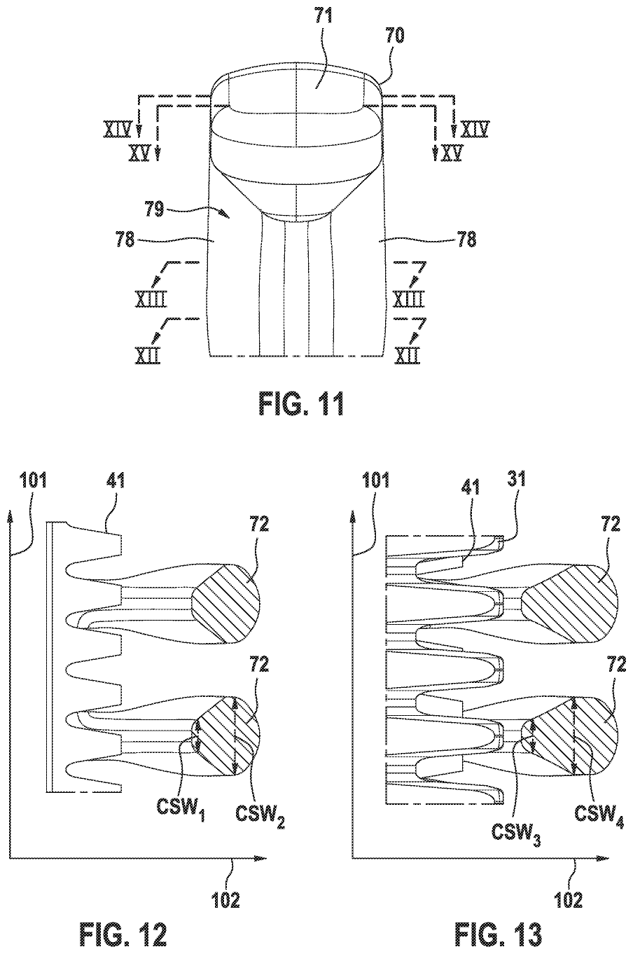

Not only the outer faces of the comb teeth 70 that face away from the blades 31, 41 but also the inner faces of the comb teeth 70 that face towards the blades 31, 41 may be designed so as to enhance cutting efficacy, as will be described with reference to FIGS. 11 to 15.

As shown in FIGS. 11 to 15, the comb teeth 70 may comprise, at their inner face facing towards the blades 31, 41 of the cutting unit 30 in the assembled state, flank surfaces 78 that get closer to each other as they approach the blades 31, 41. Thereby, one or several recesses 79 may be defined at the inner face of the comb tooth 70, e.g., at the side of the comb tooth 70 that trails the transition surface 73 when the comb 60 moves in an operational movement direction. Accordingly, comb tooth cross-sections may show a tapering cross-sectional comb tooth width, over at least part of the comb tooth 70. The taper is arranged such that the cross-sectional comb tooth width, as seen in the cross section, decreases in at least part of the comb tooth in a direction along the negative y-axis 102.

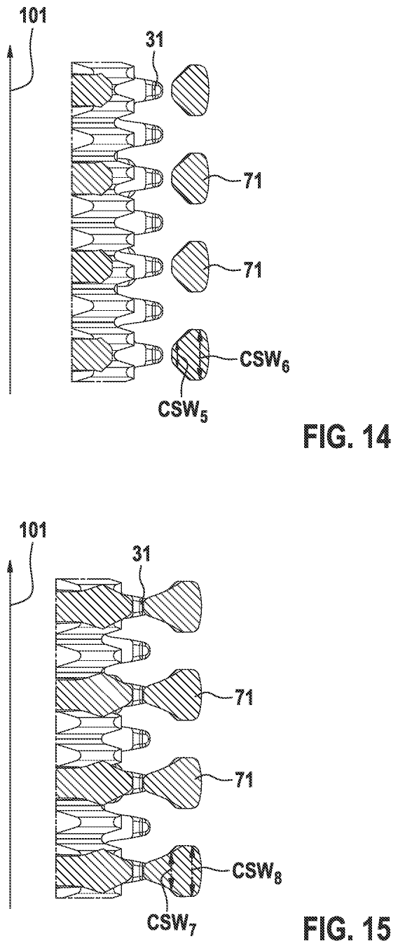

FIGS. 12 to 15 are cross-sectional views of the comb teeth 70 at positions indicates by XII-XII (FIG. 12), XIII-XIII (FIG. 13), XIV-XIV (FIG. 14), and XV-XV (FIG. 15) in FIG. 11.

As seen in FIGS. 12 and 13, a cross-sectional comb tooth width decreases from CSW₂ to CSW₁ or from CSW₄ to CSW₃ as one gets closer to the cutting blades 31, 41, i.e., as one moves away from the feeding surface 72, parallel to the second direction 102. The decrease in cross-sectional comb tooth width does not need to be strictly monotonous or even monotonous, but it may be beneficial for the cross-sectional comb tooth width (measured between points on opposite flank surfaces that are spaced parallel to the first direction 101) to decrease with increasing distance from the feeding surface 72. In this way, a recess is created on the rear or trailing side of the comb tooth 70, which allows hairs 11 to more efficiently enter gaps of the stationary blade 31 and/or moveable blade 41.

As seen in FIGS. 14 and 15, a cross-sectional comb tooth width decreases from CSW₆ to CSW₅ or from CSW₈ to CSW₇ as one gets closer to the cutting blades 31, 41, i.e., as one moves away from the skin surface 71, parallel to the second direction 102. This decrease in cross-sectional comb tooth width does not need to be strictly monotonous or even monotonous, but it may be beneficial for the cross-sectional comb tooth width (measured between points on opposite flank surfaces that are spaced parallel to the first direction 101) to decrease with increasing distance from the skin surface 71. In this way, a recess is created on the rear or trailing side of the comb tooth 70, which allows hairs 11 to more efficiently enter gaps of the stationary blade 31 and/or moveable blade 41.

The cross-sectional planes of FIGS. 12, 13 on the one hand and of FIGS. 14, 15 on the other hand may be angled relative to each other by an angle that is different from 90°. The cross-sectional planes of FIGS. 12, 13 on the one hand and of FIGS. 14, 15 on the other hand may be angled relative to each other by an angle that corresponds to the angle between the first intersection line 88 and the second intersection line 89.

While devices have been discussed with reference to FIGS. 2 to 15 in which the skin surface 71, feeding surface 72, and transition surface 73 are generally formed as smooth surfaces, one, several or all of the skin surface, feeding surface, and/or transition surface may exhibit orientational discontinuities.

For illustration, one, several or all of the skin surface, feeding surface, and/or transition surface may exhibit may be faceted surface(s) comprising flat facets, with adjacent facets being slightly angled relative to each other. Such orientational discontinuities may result from manufacturing imperfections, may be introduced deliberately (e.g., in the interest of ease of manufacturing), and/or may result from the characteristics of the material used for the comb.

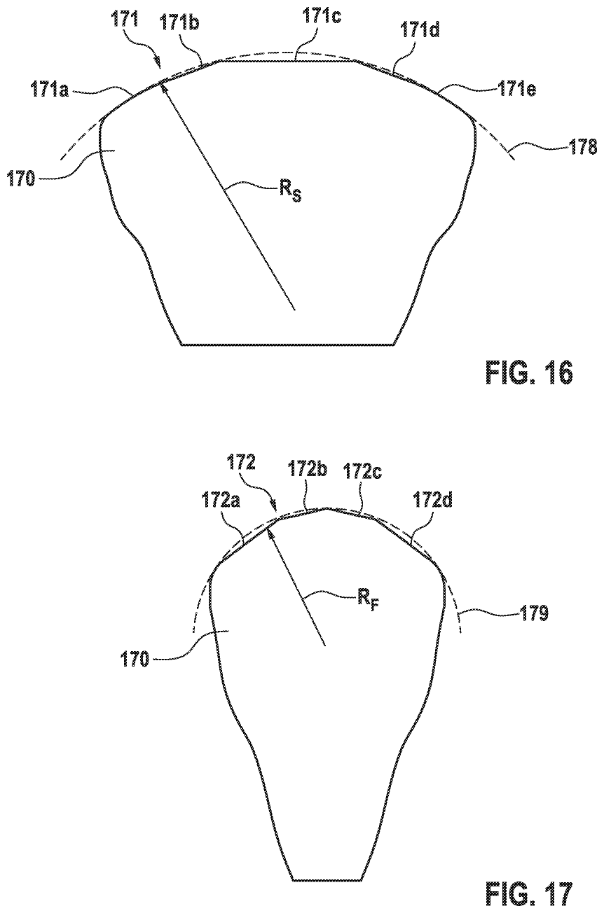

The concepts disclosed herein remain applicable when one, several or all of the skin surface, feeding surface, and/or transition surface exhibit(s) orientational discontinuities, as explained with reference to FIGS. 16 and 17.

FIG. 16 is a cross-sectional view of a comb tooth 170. A comb 60 may comprise one or several comb teeth 170, as explained above. The comb booth 170 has a skin surface 171. The skin surface 171 comprises a plurality of facets 171a-171e. Each of the facets 171a-171e may be planar or substantially planar. Adjacent facets 171a-171e may be angled relative to each other.

A cylinder segment surface 178 may be circumscribed around the facets 171a-171e of the skin surface 171. The cylinder segment surface 178 circumscribed around the facets 171a-171e of the skin surface defines a first radius of curvature R_{S} of the skin surface 171. The cylinder segment surface 178 may extend around a cylinder center axis that has a direction perpendicular to the first direction 101 along which the row of comb teeth extends.

Alternatively or additionally, the feeding surface may be a faceted surface. FIG. 17 is a cross-sectional view of a comb tooth 170. A comb 60 may comprise one or several comb teeth 170, as explained above. The comb booth 170 has a feeding surface 172. The feeding surface 172 comprises a plurality of facets 172a-172d. Each of the facets 172a-172d may be planar or substantially planar. Adjacent facets 172a-172d may be angled relative to each other.

Another cylinder segment surface 179 may be circumscribed around the facets 172a-172d of the feeding surface 172. The other cylinder segment surface 179 circumscribed around the facets 172a-172d of the skin surface defines the second radius of curvature of the feeding surface 172. The other cylinder segment surface 179 may extend around another cylinder center axis that has a direction perpendicular to the first direction 101 along which the row of comb teeth extends.

Thus, when the skin surface and/or feeding surface are not smoothly curved, the first radius of curvature may be determined as radius of a first cylinder segment circumscribed about the skin surface and/or the second radius of curvature may be determined as radius of a second cylinder segment circumscribed about the feeding surface.

Similarly, the third radius of curvature of the transition surface may be determined as a radius of a spherical or ellipsoidal cap circumscribed about the transition surface. This allows the third radius of curvature to be determined when, e.g., the transition surfaces is a faceted surface.

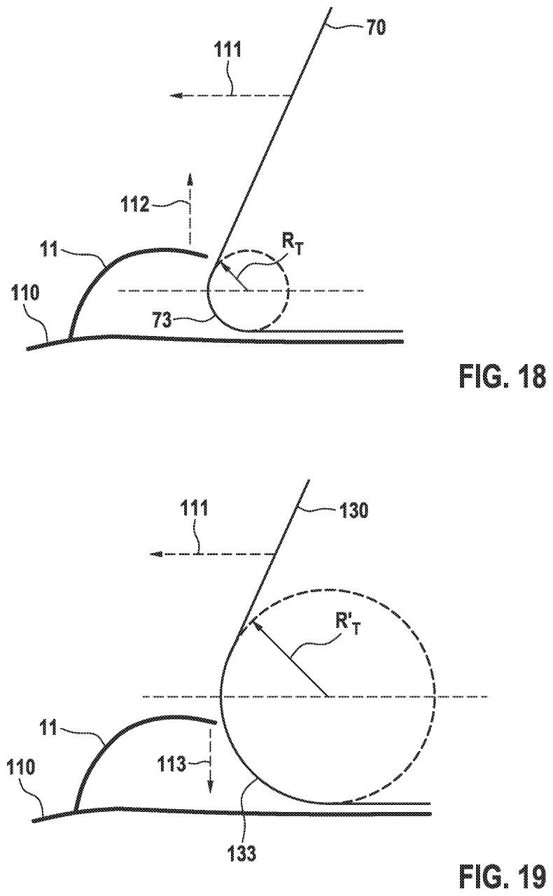

With reference to FIGS. 18 to 24, operation of a hair cutting kit having a comb according to an aspect (FIGS. 18, 20, and 22) will be compared to operation of a hair cutting kit having a comb not according to an aspect (FIGS. 19, 21, 23, and 24).

Referring to FIG. 18, a comb 60 according to an aspect has a transition surface 73 with an associated third radius of curvature R_{T} that is small (e.g., compared to the first radius of curvature R_{S} of the skin surface 71, the second radius of curvature R_{F} of the feeding surface 72, and/or the comb tooth width W). This allows the transition surface 73, which is positioned at the leading edge of the device in the operational movement direction 111, to more easily enter below a hair 11 that projects somewhat from the skin 110 and to cause the hair 11 to perform an upward movement 112. The upward movement 112 makes it more likely that the hair 11 will be properly guided towards the cutting unit by the feeding surface 72.

In FIG. 19, a comparative comb has a comparative comb tooth 130 with a transition surface 133 having a radius of curvature R′_{T} that is large (e.g., compared to a radius of curvature of the skin surface, a radius of curvature of the feeding surface, and/or the comb tooth width). This increases the risk that the transition surface 133, which is positioned at the leading edge of the device in the operational movement direction 111, cannot easily enter below a hair 11 that projects somewhat from the skin 110. The hair 11 is more likely to be pressed even closer to the skin 110 in a downward movement 113. The downward movement 113 makes it less likely that the hair 11 will be properly guided towards the cutting unit by the feeding surface.

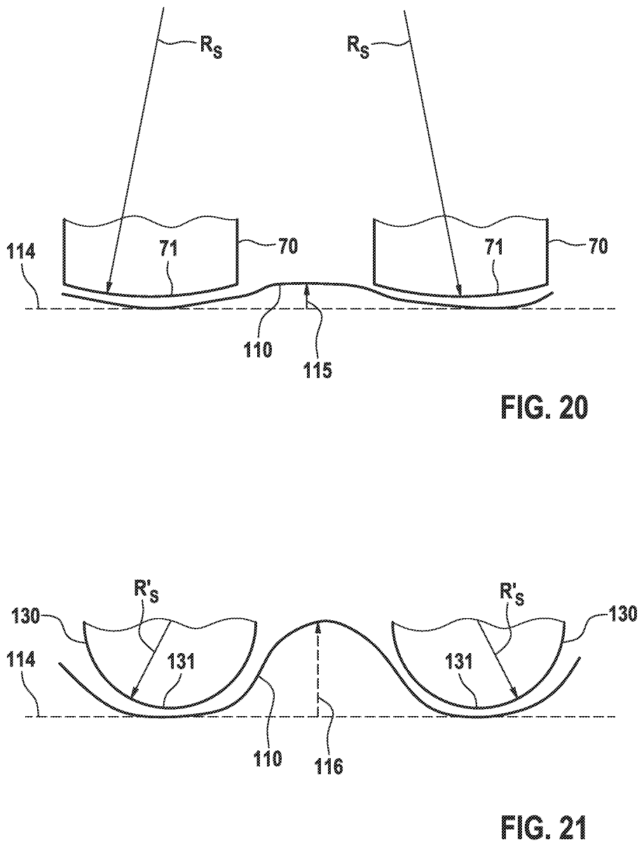

Referring to FIG. 20, a comb 60 according to an aspect has a skin surface 71 with an associated first radius of curvature R_{S} that is large (e.g., compared to the third radius of curvature R_{T} of the transition surface 73, the second radius of curvature R_{F} of the feeding surface 72, and/or the comb tooth width W). The mild curvature causes the skin 110 to only slightly bulge upward by a small distance 115 relative to its original position 114. The small amount of bulging 115 makes it less likely for the skin to be injured by the cutting unit.

In FIG. 21, a comparative comb has a comparative comb tooth 130 with a skin surface 131 having a radius of curvature R′_{S} that is small (e.g., compared to a radius of curvature of the transition surface, a radius of curvature of the feeding surface, and/or the comb tooth width). The more aggressive curvature, which results in a smaller radius of curvature, causes the skin 110 to bulge upward by a greater distance 116 relative to its original position 114. The more pronounced amount of bulging 116 makes it more likely for the skin to be injured by the cutting unit. This applies in particular when the comb with comb teeth 130 is used in body areas (such as armpit or intimate area) in which the skin is thinner and more flexible than facial skin.

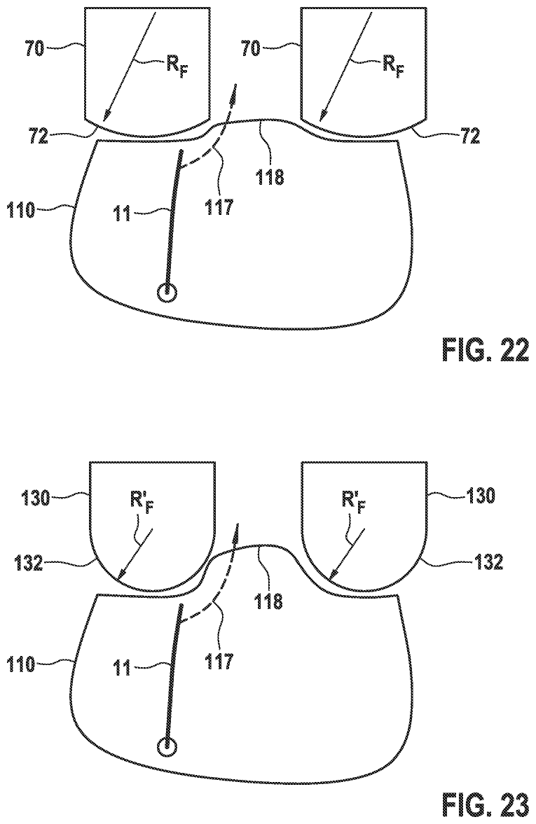

Referring to FIG. 22, a comb 60 according to an aspect has a feeding surface 72 with an associated second radius of curvature R_{F} that is chosen as an intermediate value (e.g., a value greater than the third radius of curvature R_{T} of the transition surface 73, but smaller than the first radius of curvature R_{S} of the skin surface). This compromise leads to some skin bulging 118 but allows hair 11 to be efficiently guided towards the blades of the cutting unit along a feeding path 117.

In FIG. 23, a comparative comb has a comparative comb tooth 130 with a feeding surface 132 having a radius of curvature R′_{F} that is small (e.g., both compared to a radius of curvature of the transition surface and compared to a radius of curvature of the skin surface). The more aggressive curvature, which results in a smaller radius of curvature, results in efficient guiding of the hair towards the blades 31, 41 but causes the skin 110 to bulge upward by a greater distance 118 relative to its original position 114. The more pronounced amount of bulging 118 makes it more likely for the skin to be injured by the cutting unit. The hair 11 is also guided to the blades of the cutting unit along a feeding path 117.

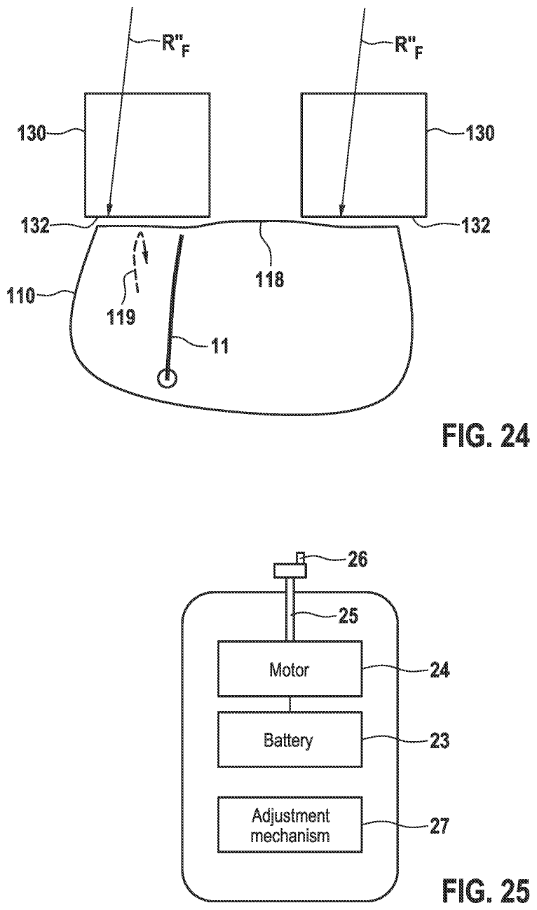

In FIG. 24, a comparative comb has a comparative comb tooth 130 with a feeding surface 132 having a radius of curvature R″_{F} that is large (e.g., both compared to a radius of curvature of the transition surface and compared to a radius of curvature of the skin surface). The less aggressive curvature, which results in a greater radius of curvature R″_{F} (which approaches infinity in the illustrated comparative comb), results in little skin bulging 118, but is incapable of effectively guiding hair 11 towards the blades 31, 41. For illustration, the hair 11 may be flattened down against the skin along a non-feeding path 119. Cutting efficiency is reduced.

The moveable blade 41 of the cutting unit 30 may be driven in various ways. FIG. 25 is a schematic block diagram of the handle 20. The handle 20 may have an outer shell in which a rechargeable battery 23 and a motor 24 are accommodated. An output shaft 25 of the motor 24 is caused to rotate during operation. A drive element 26 may be integrally formed with or attached to the output shaft 25. The drive element 26 may engage with a driven element of the cutting unit to cause the moveable blade to reciprocate, e.g., to oscillate. The handle 20 may have an adjustment mechanism 27 that allows the comb 60 to be repositioned relative to the cutting unit 30 and/or the handle 20. The adjustment mechanism 27 may include a rotary or slidable actuation element.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A hair cutting kit, in particular a hair cutting kit for body hair trimming, comprising:
a handle;
a cutting unit comprising a stationary blade and a moveable blade, the stationary blade comprising a row of first blade teeth having free first blade tooth ends, the moveable blade being configured to reciprocate relative to the stationary blade; and
a comb configured to be reversibly releasably assembled with the cutting unit and having a skin surface, the comb comprising:
a base portion opposite the skin surface and configured to face the handle when the comb is assembled with the cutting unit, and
a row of comb teeth, wherein the row of comb teeth extends in a first direction and adjacent comb teeth are separated along the first direction by gaps, wherein each comb tooth has a mid-plane that is transverse to the first direction and wherein each comb tooth extends along the mid-plane of the comb tooth,
wherein some or all of the comb teeth comprise, on an outer face that is arranged to face away from the stationary blade and from the moveable blade,
a skin surface configured to glide on a user's skin,
a feeding surface configured to feed hairs towards the cutting unit, and
a transition surface between the skin surface and the feeding surface,
wherein the skin surface has a first surface contour line extending in a first plane orthogonal to the mid-plane and having a first radius of curvature Rs, wherein the feeding surface has a second surface contour line extending in a second plane orthogonal to the mid-plane and having a second radius of curvature Rf, wherein the first radius Rs of curvature is greater than the second radius of curvature Rf.

2. The hair cutting kit of claim 1, wherein the transition surface has a third surface contour line extending in the mid-plane and having a third radius of curvature that is smaller than the second radius of curvature.

3. The hair cutting kit of claim 1, wherein the transition surface is arranged on a leading edge of the comb in an operational movement direction when the comb is assembled with the cutting unit.

4. The hair cutting kit of claim 1,
wherein the comb is configured such that, when assembled with the cutting unit, each comb tooth extends along the mid-plane from the base portion along the moveable blade, around a line along which the first blade tooth ends are positioned, and to a free comb tooth end, and/or
wherein the comb is configured such that, when assembled with the cutting unit, a free comb tooth end of some or all of the comb teeth partially overlaps at least some of the first blade teeth when viewed in a viewing direction that is orthogonal to a plane along which the moveable blade abuts on the stationary blade, and/or
wherein the comb further comprises ridges extending transversely to the first direction and separated from the free tooth ends of the comb teeth by a further gap, optionally wherein some, a majority, or all of the ridges extend along the mid-planes of the comb teeth.

5. The hair cutting kit of claim 1,
wherein each comb tooth has a recess at a side opposite the skin surface, and/or
wherein a cross-sectional width of the comb tooth measured along the first direction in the first plane or a cross-sectional plane that is parallel to the first plane passing through the skin surface decreases in at least part of the comb tooth in a direction away from the skin surface, and/or
wherein another cross-sectional width of the comb tooth measured along the first direction in the second plane or another cross-sectional plane that is parallel to the second plane passing through the feeding surface decreases in at least part of the comb tooth in a direction away from the feeding surface.

6. A hair cutting kit, in particular a hair cutting kit for body hair trimming, comprising:
a handle;
a cutting unit comprising a stationary blade and a moveable blade, the stationary blade comprising a row of first blade teeth having free first blade tooth ends, the moveable blade being configured to reciprocate relative to the stationary blade; and
a comb configured to be reversibly releasably assembled with the cutting unit and having a skin surface, the comb comprising:
a base portion opposite the skin surface and configured to face the handle when the comb is assembled with the cutting unit, and
a row of comb teeth, wherein the row of comb teeth extends in a first direction and adjacent comb teeth are separated along the first direction by gaps, wherein each comb tooth has a mid-plane that is transverse to the first direction and wherein each comb tooth extends along the mid-plane of the comb tooth,
wherein some or all of the comb teeth comprise, on an outer face that is arranged to face away from the stationary blade and from the moveable blade,
a skin surface configured to glide on a user's skin,
a feeding surface configured to feed hairs towards the cutting unit, and
a transition surface between the skin surface and the feeding surface,
wherein a first cylinder segment surface circumscribed about the skin surface has a first radius of curvature, wherein a second cylinder segment surface circumscribed about the feeding surface has a second radius of curvature, wherein the first radius of curvature is greater than the second radius of curvature.

7. The hair cutting kit of claim 6, wherein a spherical or ellipsoidal surface circumscribed about the transition surface has a third radius of curvature that is smaller than the second radius of curvature.

8. The hair cutting kit of claim 6, wherein the transition surface is arranged on a leading edge of the comb in an operational movement direction when the comb is assembled with the cutting unit.

9. The hair cutting kit of claim 6,
wherein the comb is configured such that, when assembled with the cutting unit, each comb tooth extends along the mid-plane from the base portion along the moveable blade, around a line along which the first blade tooth ends are positioned, and to a free comb tooth end, and/or
wherein the comb is configured such that, when assembled with the cutting unit, a free comb tooth end of some or all of the comb teeth partially overlaps at least some of the first blade teeth when viewed in a viewing direction that is orthogonal to a plane along which the moveable blade abuts on the stationary blade, and/or
wherein the comb further comprises ridges extending transversely to the first direction and separated from the free tooth ends of the comb teeth by a further gap, optionally wherein some, a majority, or all of the ridges extend along the mid-planes of the comb teeth.

10. The hair cutting kit of claim 6, wherein the comb teeth respectively have a comb tooth width, the comb tooth width being a distance between two outermost tangential planes to a comb tooth with the outermost tangential planes being perpendicular to the first direction.

11. The hair cutting kit of claim 10, wherein the first radius of curvature is greater than the comb tooth width.

12. The hair cutting kit of claim 10, wherein the second radius of curvature is smaller than the comb tooth width.

13. The hair cutting kit of claim 10, wherein the second radius of curvature is greater than 0.5 times the comb tooth width.

14. The hair cutting kit of claim 10 wherein the transition surface has a third surface contour line extending in the mid-plane and having a third radius of curvature that is smaller than the second radius of curvature and wherein the third radius of curvature is smaller than about 0.5 times the comb tooth width and/or greater than about 0.1 times the comb tooth width.

15. The hair cutting kit of claim 6,
wherein the skin surface comprises a first cylinder segment surface along at least a portion thereof, the first cylinder segment surface having the first radius of curvature, and/or
wherein the feeding surface comprises a second cylinder segment surface along at least a portion thereof, the second cylinder segment surface having the second radius of curvature.

16. The hair cutting kit of claim 6, wherein the mid-plane intersects the skin surface along a first intersection line and the mid-plane intersects the feeding surface along a second intersection line,
wherein the first intersection line is angled relative to the second intersection line, optionally wherein an angle between the first intersection line and the second intersection line is less than about 90° or less than about 80°, and/or
the first intersection line and the second intersection line are angled relative to a plane along which the moveable blade abuts on the stationary blade when the comb is assembled.

17. The hair cutting kit of claim 6,
wherein each comb tooth has a recess at a side opposite the skin surface, and/or
wherein a cross-sectional width of the comb tooth measured along the first direction in the first plane or a cross-sectional plane that is parallel to the first plane passing through the skin surface decreases in at least part of the comb tooth in a direction away from the skin surface, and/or
wherein another cross-sectional width of the comb tooth measured along the first direction in the second plane or another cross-sectional plane that is parallel to the second plane passing through the feeding surface decreases in at least part of the comb tooth in a direction away from the feeding surface.

18. The hair cutting kit of claim 6, wherein the skin surface extends at a distance of at least about 0.3 mm or at least about 0.5 mm from a plane along which the moveable blade abuts the stationary blade.

19. The hair cutting kit of claim 6, further comprising a handle comprising an electric motor having a motor shaft and a drive element coupled to the motor shaft and operative to drive the moveable blade, optionally wherein the handle comprises a rechargeable battery.
